(19) United States
(12) Patent Application Publication
(10) Pub. No.: US 2010/0045600 A1
(43) Pub. Date: Feb. 25, 2010

(54) COMBINED MOUSE AND JOYSTICK INPUT DEVICE

(75) Inventors: Adam Pilkington, Southampton (GB); Simon C.E. Rowland, Winchester (GB)

Correspondence Address: IBM - EU c/o Myers Andras Sherman LLP, 19900 MacArthur Blvd., Suite 1150, Irvine, CA, 92612, US

(73) Assignee: International Business Machines Corporation, Armonk, NY (US)

(21) Appl. No.: 12/197,918

(22) Filed: Aug. 25, 2008

(51) Int. Cl. G06F 3/033

(52) U.S. Cl. 345/161

(57) ABSTRACT

A position input device is provided. The input device includes a mouse module configured for providing coarse position information, the mouse including a body having a housing, and a joystick module configured for providing fine position information, the joystick being disposed in the housing and supported by the mouse body, wherein the joystick has a retracted position and an extended position relative to the housing, such that in the extended position, movement of the joystick provides fine position information.

### BACKGROUND OF THE INVENTION

1. Field of the Invention

The invention relates to input devices and in particular to mice and joysticks.

2. Background Information

Input devices, such as mice and joysticks are popular devices for interacting with electronic devices, such as computers and game counsels. Existing mice, however, do not provide sufficient fine grained control for users in many circumstances such as drawing or writing a signature. Conventional approaches for fine grained control either involve modifying mice to provide additional input options for fine grained control, or providing a separate input device such as a digital tablet.

### BRIEF SUMMARY OF THE INVENTION

The invention provides a position input device. One embodiment of the input device comprises a mouse module configured for providing coarse position information, the mouse including a body having a housing, and a joystick module configured for providing fine position information, the joystick being disposed in the housing and supported by the mouse body, wherein the joystick has a retracted position and an extended position relative to the housing, such that in the extended position, movement of the joystick provides fine position information.

The input device may further include a controller configured such that when the joystick is in the retracted position, the controller provides coarse position information based on movements of the mouse, and when the joystick is extended, the controller provides fine position information based on movements of the joystick.

These and other features, aspects and advantages of the invention will become understood with reference to the following description, appended claims and accompanying figures.

### BRIEF DESCRIPTION OF THE DRAWINGS

FIG. 1 shows a side view of a user input device, according to an embodiment of the invention.

FIG. 2 shows another side view of a user input device combining a mouse and a joystick, according to an embodiment of the invention.

FIG. 3 shows an example implementation of a telescopic joystick.

### DETAILED DESCRIPTION OF THE INVENTION

The following description is made for the purpose of illustrating the general principles of the invention and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

The description may disclose several preferred embodiments of input devices, as well as operation and/or component parts thereof. While the following description will be described in terms of a combined mouse and joystick device for clarity and to place the invention in context, it should be kept in mind that the teachings herein may have broad application to all types of systems, devices and applications.

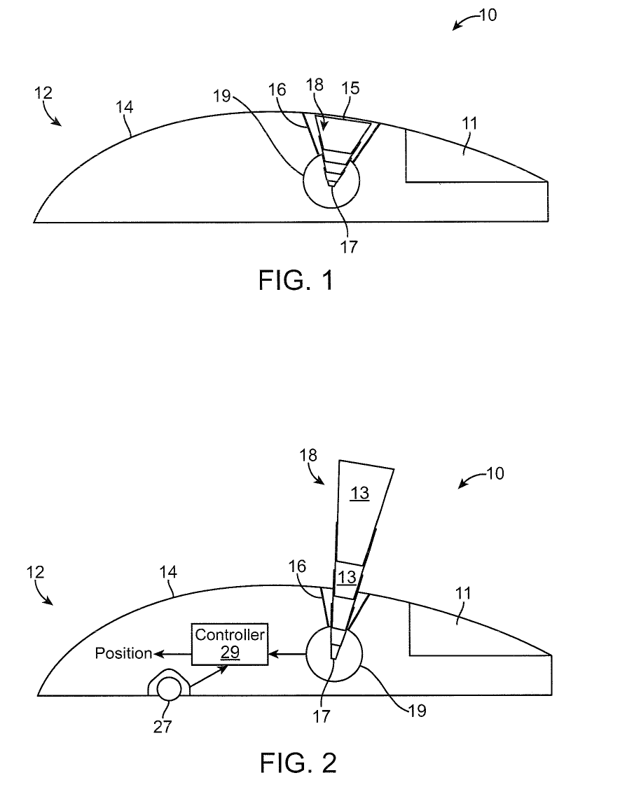

The invention provides a combined coarse and fine control input device. Referring to FIG. 1, according to an embodiment of the invention, an input device 10 comprises a mouse 12 having a body 14 including a housing 16 into which a joystick 18 is movably recessed. The mouse may include button(s) 11. Movements of the mouse 12 relative to a support surface provides coarse positioning such as for control of a pointer on a computer display screen, while the joystick provides finer positioning control. When the joystick 18 is in its recessed position, pressing on top 15 of the joystick 18 causes at least a portion of the joystick 18 out of the housing 16, as shown in FIG. 2. The extended joystick 18 can then be utilized by a user for finer control. For example, the joystick can be gripped between the thumb and forefinger and used for input. When finished, the joystick 18 can be depressed back into the housing in the mouse body.

Preferably, the joystick 18 is recessed in the body of the mouse so that the top of the joystick is flush with the top of the mouse (FIG. 1). The joystick 18 may be constructed from telescopic sections 13 (FIG. 2) which allows It to be compressed when not in use. The bottom of the joystick contains a laser 17 for sensing joystick movement and is sited in a hollow chamber 19 (essentially spherical) for sensing joystick movement via the laser. The laser is disposed in the chamber, such that movement of the joystick causes movement of a beam from the laser in an inner surface of the chamber, indicating movement of the joystick for fine position information.

The joystick 18 may be spring-loaded, wherein depressing the top of the joystick causes (or pressing button 11) the joystick to extend out of the housing 16 as shown in FIG. 2. The joystick is gripped between the thumb and forefinger with the laser providing the tracking information over the inner surface of the hollow chamber 19. Once finished, then the top 15 of the joystick is pressed to recess back into the housing 16 (FIG. 1). Preferably the mouse 12 is kept stationary when joystick 18 is used for fine control.

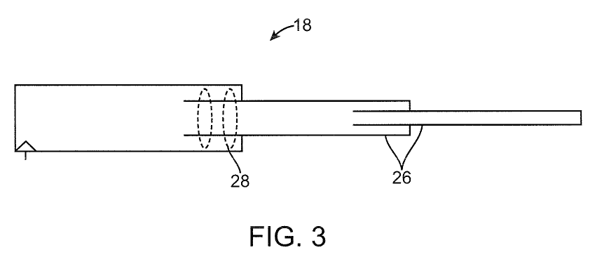

FIG. 3 shows an example telescopic sensor for another implementation of the joystick 18, comprising telescopic segments 26 which do not significantly change the width of the joystick as they extend out of the housing 16. Each segment is only wide enough to accommodate the lower section when the joystick is retracted (recessed into the housing 16). Each segment is straight, and slides into the next segment. The telescope is thus constructed of a series of nested straight segments 26.

As noted, the joystick 18 may be spring-loaded via spring(s) 28, wherein depressing the top of the joystick causes (or pressing button 11) the joystick to extend out of the housing 16. In one example, the inside of the joystick contains the spring 28 which is compressed when the joystick is retracted into the housing, and extends the joystick when released by pressing down on the top of the joystick. The spring mechanism may include a ratchet function such as in a ballpoint pen with a retractable nib (i.e., one click for lock in a retracted position, another click to lock in an extended position).

In one example, the detected movement of the mouse via, e.g., a track ball 27 (or laser) and the detected movement of the joystick 18 via the laser 17, are translated into movements of a pointer on a computer display screen to which the input device is connected. Translation of such movement to position control on the screen can be implemented by a controller 29 (FIG. 2). The controller 29 can be calibrated such that when the mouse is used with the joystick retracted, the controller provides coarse position information based on the mouse movements, and when the joystick is extended and moved (with the mouse remaining essentially stationary) the controller provides fine position information based on the joystick movement. The controller can also be calibrated the same way for the mouse and the joystick operations.

The joystick provides all ranges of movement with fine accuracy. The joystick may also use the usual mouse buttons 11 for user input. Using laser detection provides the joystick with a more accurate pointing function. Embodiments of the invention provide a retractable joystick with the retraction and extension controlling whether or not input is from the mouse or joystick rather than using a switch (i.e., when the joystick is extended, input is from the joystick and when the joystick is retracted, input is from the mouse).

In the description above, numerous specific details are set forth. However, it is understood that embodiments of the invention may be practiced without these specific details. For example, well-known equivalent components and elements may be substituted in place of those described herein, and similarly, well-known equivalent techniques may be substituted in place of the particular techniques disclosed. In other instances, well-known structures and techniques have not been shown in detail to avoid obscuring the understanding of this description.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element. In either case, the controller can sense when the joystick is retracted, thereby providing coarse position information only based on movements of the mouse. The controller can further sense when the joystick is extended, thereby providing fine position information only based on movements of the joystick.

The invention has been described in considerable detail with reference to certain preferred versions thereof; however, other versions are possible. Therefore, the spirit and scope of the appended claims should not be limited to the description of the preferred versions contained herein.

What is claimed is:

1. A position input device, comprising:
a mouse module configured for providing coarse position information, the mouse including a body having a housing; and
a joystick module configured for providing fine position information, the joystick being disposed in the housing and supported by the mouse body;
wherein the joystick has a retracted position and an extended position relative to the housing, such that in the extended position, movement of the joystick provides fine position information.

2. The input device of claim 1 further including a controller configured such that when the joystick is in the retracted position, the controller provides coarse position information based on movements of the mouse, and when the joystick is extended, the controller provides fine position information based on movements of the joystick.

3. The input device of claim 2, wherein the joystick includes a telescopic control that can be collapsed into the housing for the retracted position of the joystick, and that can be extended out of the housing for the extended position of the joystick.

4. The input device of claim 2, wherein the housing forms a chamber and the joystick includes a laser module disposed in the chamber, such that movement of the joystick causes movement of a beam from the laser in an inner surface of the chamber, indicating movement of the joystick for fine position information.

5. A position input apparatus comprising a combined mouse module and joystick module in a body, the body defining a housing such that the joystick is disposed in the housing and supported by the body, the joystick having a retracted position and an extended position relative to the housing, such that in the retracted position movement of the mouse provides coarse position information and in the extended position movement of the joystick provides fine position information.

6. The apparatus of claim 5 further including a controller configured such that when the joystick is in the retracted position, the controller provides coarse position information based on movements of the mouse, and when the joystick is extended, the controller provides fine position information based on movements of the joystick.

7. The apparatus of claim 5, wherein the joystick includes a telescopic control that can be collapsed into the housing for the retracted position of the joystick, and that can be extended out of the housing for the extended position of the joystick.

8. The apparatus of claim 5, wherein the housing forms a chamber and the joystick includes a laser module disposed in the chamber, such that movement of the joystick causes movement of a beam from the laser in an inner surface of the chamber, indicating movement of the joystick for fine position information.
